(19) United States
(12) Patent Application Publication
(10) Pub. No.: US 2024/0298166 A1
(43) Pub. Date: Sep. 5, 2024

(54) Modifying Communication Behavior of a Communication Device

(71) Applicant: Telefonaktiebolaget LM Ericsson (PUBL), Stockholm (SE)

(72) Inventors: Gunnar Mildh, Sollentuna (SE); Icaro Leonardo Da Silva, Solna (SE); Szilveszter Nádas, Santa Clara, CA (US); Gergely Pongrácz, Budapest (HU); Zoltán Richárd Turányi, Szentendre (HU)

(21) Appl. No.: 18/574,452

(22) PCT Filed: Jun. 20, 2021
(86) PCT No.: PCT/SE2021/050653

§ 371 Date: Dec. 27, 2023

(51) Int. Cl. H04W 8/18; H04W 8/22; H04W 48/18; H04W 76/20

(52) U.S. Cl. CPC H04W 8/183; H04W 8/22; H04W 48/18; H04W 76/20

(57) ABSTRACT

A communication device (600), a network node (600) and methods for modifying the communication behaviour of the communication device (600) with regards to communication in a network. The communication behaviour is modified by controlling the functionality of the communication device. The communication device performs a method (300) of providing (310) at least one programmability capability indicator (PCI) to a network node (700). The communication device obtains (320) from the network node, configuration instructions provided in response to the provided PCI, and updates (330) the communication behaviour utilizing the obtained configuration instructions. Computer programs and a computer program product are also disclosed.

### TECHNICAL FIELD

The disclosure herein relates to a communication device and a network node in a wireless communications network, and methods thereof. In particular, the embodiments relate to modifying the communication behaviour of a communication device communicating in a network. Computer programs and a computer program product are also disclosed.

### BACKGROUND

In 3^{rd} Generation Partnership Project (3GPP) systems, such as 5^{th} Generation (5G) New Radio (NR) and Long-Term Evolution (LTE), various protocols form a protocol stack for communication between a user Equipment (UE) and a radio access network (RAN). The protocol stack can be divided into Control Plane (for signalling), see FIG. 1, and User Plane (for data) see FIG. 2.

The Control Plane can comprise sublayers such as a Package data convergence protocol (PDCP), a Radio Link Control (RLC), a Medium access control (MAC) and Radio Resource Control (RRC) which terminate in a gNB on the network side. The Non-access stratum (NAS) control protocol terminates in the Access and Mobility Management Function (AMF) on the network side, see FIG. 1. The User Plane can comprise sublayers such as Service Data Adaption Protocol (SDAP), PDCP, RLC and MAC, which terminate in a gNodeB (gNB) on the network side, see FIG. 2.

The functions executed by these protocols are specified in 3GPP specifications, e.g. the main control plane protocol, RRC, is specified in 3GPP TS 38.331, V 16.1.0, which discloses the following protocol functions for implementation at the UE side:
Broadcast of System Information related to Access Stratum (AS) and NAS;
Paging initiated by 5G Core (5GC) or Next Generation Radio Access network (NG-RAN)
Establishment, maintenance and release of an RRC connection between the UE and NG-RAN including:
   Addition, modification and release of carrier aggregation;
   Addition, modification and release of Dual Connectivity in NR or between a Evolved Universal mobile Telecommunications System Terrestrial Radio Access (E-UTRA) and NR.
Security functions including key management;
Establishment, configuration, maintenance and release of Signalling Radio Bearers (SRBs) and Data Radio Bearers (DBRs);
Mobility functions including:
   Handover and context transfer;
   UE cell selection and reselection and control of cell selection and reselection.
   Inter-Radio Access Technology (RAT) mobility
Quality of Service (QOS) management functions;
UE measurement reporting and control of the reporting;
Detection of and recovery from radio link failure;
NAS Message transfer to/from NAS from/to UE.

Sidelink (SL) (direct device to device communication) specific services and functions of the RRC sublayer over a Uu interface include:
Configuration of SL resource allocation via system information or dedicated signalling;
Reporting of UE SL information;
Measurement configuration and reporting related to SL
Reporting of UE assistance information for SL traffic pattern(s).

Once these functions are specified, UE manufacturers can implement them according to these specifications, and a network manufacturer can implement the counter-part of these functions, taking into account what has been specified.

However, what UE behaviour the network manufacturer can explore when programming a UE's software is limited to what has been specified. For example, a network vendor can design a handover algorithm based on A1-A6 events, see TS 38.331 V 16.1.0, Clauses 5.5.4.1-5.5.4.7, to take a handover decision, for example in response to a certain configuration and process measurement report. Further, the introduction of a new event, a new trigger, and/or a new report associated with a handover decision would require standardization.

Recent initiatives, such as separation between Control Plane and User Plane functions, and the opening of Application Programming Interfaces (APIs) that could be used by a third party, so that control functions could be programmed. In addition, virtualization and cloud technologies have been used to program APIs on the network side.

In the RAN domain, initiatives in the area of RAN programmability have also started to emerge. However, they have been limited to initiatives to open API(s) on the network side, so that a third part vendor could use these opened API(s) to program algorithms.

The benefits are limited to functions and/or features a terminal and/or a UE would support in a given version of the 3GPP specifications. In other words, while a programmer benefitting from opened API's could design a new scheduling algorithm, programmers cannot substantially influence the type of information a terminal reports, or some specific behavior of the UE upon receiving a given command: the type of information or specific behavior would have to be introduced via standardization.

Even if the UE behavior is updated in the standards, network vendors must support legacy behavior for a long period of time. This makes standardization cautious, and also network design more and more complex as the given generation of mobile network evolves.

### SUMMARY

An object of embodiments herein is to enable a synchronization of communication software between network node and a communication device by controlling functionalities of the communication device.

According to a first aspect a method is provided for a communication device for modifying a communication behaviour of the communication device with regard to communication in a network. The communication behaviour is modified by controlling the functionality of the communication device, wherein the method comprises providing at least one programmability capability indicator to a network node, obtaining, from the network node, configuration instructions, provided in response to the providing of the at least one programmability capability indicator, and updating the communication behaviour utilizing the obtained configuration instructions.

Hereby is achieved that the communication device is enabled to utilize capabilities recognized by a network node.

According to a second aspect a communication device is provided for communicating with a communications network, the communication device comprising a transceiver, a processor, and a memory. The memory storing instruction that, when executed by the processor, causes the communication device to modify the communication behaviour of the communication device by controlling the functionality of the communication device. The communication device is further adapted to provide at least one programmability capability indicator to a network node, obtain, from the network node, configuration instructions based on the programmability capability indicator, update the communication device's behaviour utilizing the configuration instructions based on the programmability capability indicator.

A third aspect is a method performed by a network node for enabling the modification of at least one communication device's communication behaviour with regard to how the communication device communicates in a network. The method comprises obtaining at least one programmability capability indicator from the at least one communication device, providing the communication device with configuration instructions which utilize one or more of the at least one programmability capability indicators obtained from the communication device.

In a fourth aspect, a network node is provide comprising a transceiver, a processor, and a memory. The memory storing instructions that when executed by the processor cause the network node to modify the communication behaviour of at least one communication device with regard to how the communication device communicates in a network. The network node being further adapted to obtain at least one programmability capability indicator from the at least one communication device, provide the communication device with configuration instructions which utilize one or more of the at least one programmability capability indicators obtained from the communication device.

In a fifth aspect a computer program comprising program code is provided. The program code to be executed by at least one processor of a communication device whereby the execution of the program code causes the communication device to perform operations according the first aspect and embodiments thereof.

In a sixth aspect, a computer program comprising program code is provided. The program code to be executed by at least one processor of a network node whereby the execution of the program code causes the network node to perform operations according to the third aspect and embodiments thereof.

A seventh aspect is a computer program product comprising a computer program. The computer program as in the fifth or sixth aspect. Further provided is a computer readable means on which the computer program is stored.

### BRIEF DESCRIPTION OF THE DRAWINGS

The disclosure is now described, by way of example, with reference to the accompanying drawings, in which:

FIG. 1 illustrates protocol stacks comprised within the control plane;

FIG. 2 illustrates protocol stacks comprised within the user plane;

FIGS. 3 & 4 are flow charts of methods of modifying a communications device behaviour;

FIG. 5 is a signal diagram of signalling between a communication device and a network node for modifying a communication device behaviour;

FIG. 6 is a block diagram of a communication device according to an embodiment;

FIG. 7 is a block diagram of a network node according to an embodiment.

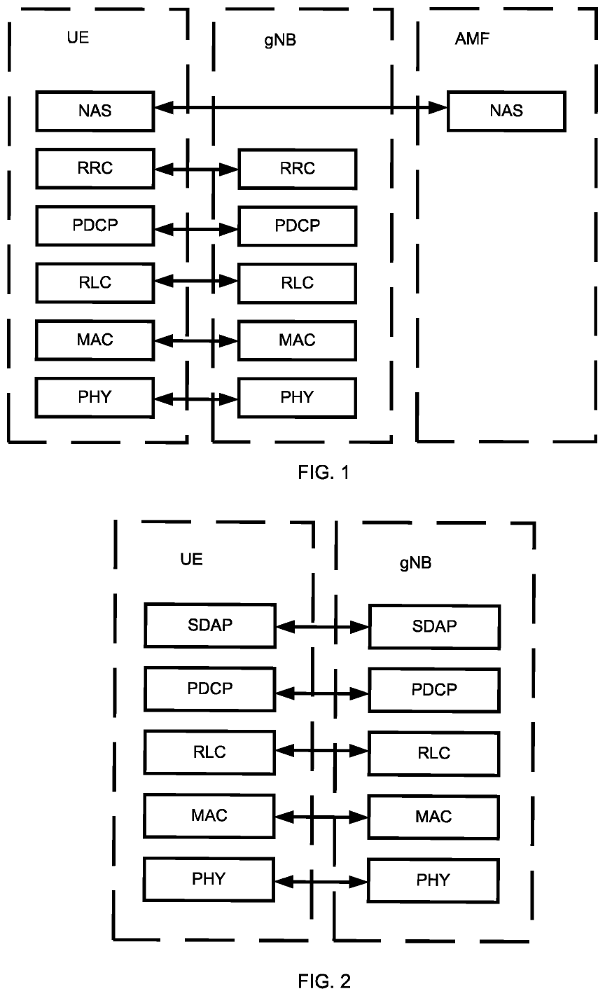

### DETAILED DESCRIPTION

The disclosure will now be described more in detail hereinafter with reference to the accompanying drawings, in which certain embodiments of the disclosure are shown. This disclosure may, however, be embodied in many different forms and should not be construed as limited to the embodiments set forth herein; rather, these embodiments are provided as examples of embodiments within the claimed scope.

One of the main problems that exist in relation to realizing a communication device programmability framework for a 3GPP protocol stack or equivalent is how to achieve a synchronization of a network and the communication device so that there is a certainty that both the network and the communication device are running the same or compliant software versions of a given protocol stack.

A second problem is that in order to utilize new wireless device capabilities related to programmability of a wireless device, it is required that the provider (i.e. the network node) of the downloadable configurations are aware of the communication device's capabilities, and that these capabilities are expressed in a format that the provider understands.

An advantage of disclosed embodiments will be an increased flexibility in the implementation of new features to a network and a communication device. Such implementation can be made without any new hardware or new devices which support new standard releases. This proves advantageous as it enables optimization of the performance for a communication device e.g. for example, an increase in bit-rates in a transmission, a reduction in energy usage at the communication device, an increase in the energy efficiency at the communication device. Such optimization yields resource efficiencies for example, an increase in the battery life per unit power. Further efficiency improvements provided are related to software (SW) provisioning.

Other advantages include the possibility to gradually introduce and utilize new communication device hardware or firmware in existing networks. This can be enabled by the communication device reporting to the network node that the device supports a new feature, e.g. includes hardware or firmware enabling the network node to utilize the feature, such feature being e.g. to optimize network performance and/or other communication behaviours.

As such, embodiments presented herein improve how communication behaviour of a communication device can be modified. In some embodiments, such modification may be enabled utilizing software components or configuration information comprised within configuration instructions.

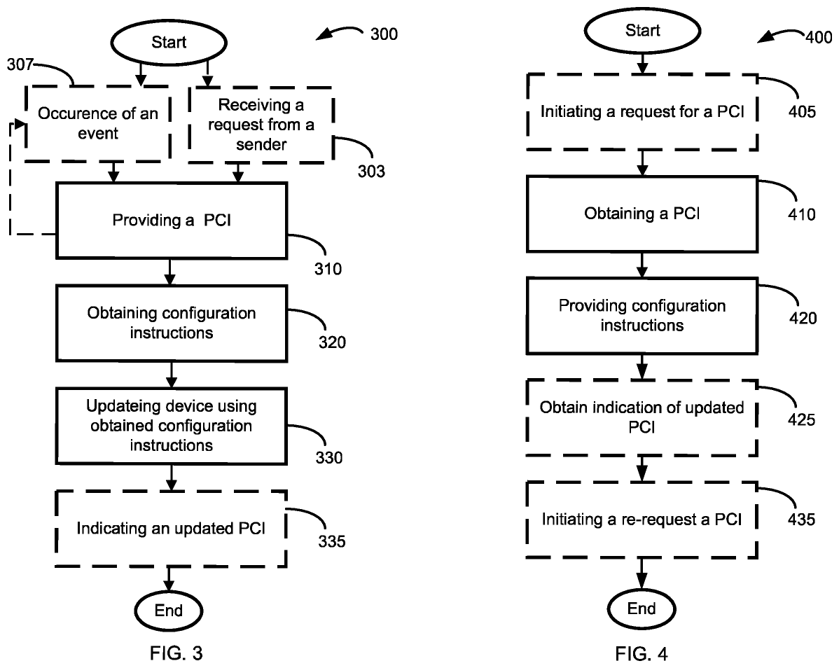

FIG. 3 and FIG. 4 are flow charts illustrating embodiments of methods for modifying the communication behaviour of a communication device.

FIG. 3 illustrates a method 300 performed by a communication device for modifying a communication behaviour of the communication device with regard to communication in a network. The communication behaviour of the communication device is modified by controlling the functionality of the communication device. The method for modifying the communication behaviour comprises providing 310 at least one programmability capability indicator (PCI) to a network node 700, obtaining 320, from the network node, configuration instructions provided in response to the providing of the at least one PCI and updating 330 the communication behaviour utilizing the obtained configuration.

In the, updating 330, step the communication device utilizes the obtained configuration instructions to update communication behaviour of the communication device. The update modifies the behaviour of the communication device according to the configuration instructions. Further, the modified communication behaviour may be a protocol behaviour of the communication device, the protocol behaviour being the behaviour of the communication device controlled by a protocol, e.g. how to send information to a network, the timing of when and how to send messages, how and what to search when searching neighbouring cells signal strength, such protocol behaviour being enabled to be modified by the insertion of new features, e.g. new timers, or handover functions, or power saving modes when not communicating to a network.

The providing 310 of a PCI may be an uploading or a sending of the PCI. For example, the uploading of the PCI may be performed using file transfer protocol (FTP), Secure Shell (SSH) File transfer Protocol (SFTP) or Hypertext Transfer Protocol (HTTP). Further, when uploading the PCI using FTP, SFTP or HTTP the PCI could be transferred as a file. For example, a (S)FTP messages may be a (S)FTP GET or MGET messages, and (S)FTP PUT or MPUT messages, and a HTTP message may be a HTTP GET or HTTP POST message. The file format could in one instance be an Extensible Markup Language (XML) format, in another example the file could be a serialized data format, for example JavaScript Object Notation (JSON), YAML Ain′t Markup Language (YAML), or Protobuf. A further example is wherein the sending of the PCI may comprise sending the PCI as an information element in a Radio Resource Control (RRC) or a Non-access stratum (NAS) signalling. An example of sending the PCI using RRC or NAS signalling comprises transferring data as an Abstract Syntax notation One (ASN.1) formatted message, other formats could include JSON, YAML, or Protobuf. In some embodiments, the communication device provides the PCI by providing a pointer or an index to a predefined set of PCI. In other words, the pointer or index may point to a location comprising indications of a set of PCI, that a receiver can obtain. In another embodiment, such a pointer is a URL to a server, from which the receiver can retrieve the PCI. In an embodiment the communication device provides the PCI to an over-the-top server.

The PCI comprises information describing how the communication device can be programmed, with regards to the capabilities comprised within the communication devices. The information describing how the communication device can be programmed may be expressed as, for example, a programmability capability description file, or, as a further example, a programmability capability model, e.g. a data model. Specifically, the PCI may comprise a description or an indication of the capabilities that the communication device has which are programmable. The PCI may consist of multiple separate description files, information elements or programmability capability models.

For example, a PCI may comprise an indication that a protocol stack is programmable, as used herein a protocol stack that is programmable means that a feature of the protocol stack is modifiable beyond configurability of functions existing in standardization, e.g. the addition of a new timer. In other words, the PCI indicates the programmability of a protocol stack, e.g. RRC, PDCP, RLC, MAC, and Physical Layer (PHY) for Access Stratum and NAS.

The programmability of a protocol stack may be further specified by an indication of support for programmability per protocol within a protocol stack, for example, if the RRC in the AS supports programmability. Further granularity can be achieved by enabling the PCI to indicate support for the programmability per function within a protocol within a protocol stack, for example if a function, such as connection control, measurement configuration or measurement reporting within RRC, supports programmability. In other words, in an embodiment, the PCI indicates support for the programmability per protocol stack, per protocol within a protocol stack, and/or per function within a protocol.

Information comprised within the PCI may include an indication of support for one or more application programming interface (API). The API may comprise APIs to a service layer, and/or an Operating System layer and/or an application layer function. The service layer may be a service layer of an Internet Protocol Multimedia Subsystem (IMS). Further, the API comprises in some embodiments an API to a Wi-Fi module, and/or external data storage and/or other modules, wherein the other modules in some embodiments are managed by another entity than a cellular network. More specifically, an API may be associated with different levels of the communication network such as the Radio Access network, the core network, and the transport network. e.g. Network API X, Radio API Y, wherein X and Y are generic versioning of a Network API and a Radio API respectively.

Further, the information comprised within the PCI may include an indication of available processing HW, for example, a central processing unit (CPU), a Graphic processing unit (GPU), a tensor unit, a HW accelerator, which can be programmed to be utilized to control the functionality of the communication device. Even further, the information comprised within the PCI may comprise an indication of memory, e.g. CPU cache, Static Random-access memory (SRAM), Dynamic random-access memory (DRAM), which can be programmed to be utilized to control the functionality of the communication device. In other words, the PCI may be an indication of processing HW or memory capabilities.

The information comprised within the PCI includes in some embodiments an indication of supported bit-rates, or package processing capabilities, e.g. bits per second, or packets per second. The information comprised within the PCI may even further be an indication of supported HW components, e.g. sensors, Global navigation Satellite System (GNSS) position, Wi-Fi, Bluetooth, security processing.

In a further embodiment the PCIs comprises private or vendor specific programmability capability information. The private or vendor specific programmability capability information may be restricted to only be provided to receivers supported by the device vendor. In other words, all, none or a subset of the PCIs in an embodiment are private or vendor specific.

In an embodiment of the obtaining 320 step, the communication device obtains configuration instructions from an over-the-top server.

The configuration instructions may for example be obtained as an information element in RRC or NAS signalling, in a signalling message, or in an HTTP, FTP, or SFTP message. Further, when obtaining 320 the configuration instructions using FTP, SFTP or HTTP, the configuration instructions could be transferred as a file. An example of (S)FTP messages are (S)FTP GET or MGET messages, and (S)FTP PUT or MPUT messages. Examples of a HTTP message are a HTTP GET and HTTP POST message. The file format could in one instance be an XML format, in another example, the file could be a serialized data format, for example JSON, YAML, or Protobuf. An example of obtaining the configuration instructions using RRC or NAS signalling comprises transferring data as an ASN.1 formatted message.

In an embodiment, the obtained configuration instructions relate to any one or more of radio processing, packet processing, a network selection, and a service layer functionality of the communication device.

Ever further, the configuration instructions may be a software or configuration information regarding the provided PCIs. For example, such configuration instructions could be instructions to a communication device to utilize specific types of API calls, these API calls being compatible with a provided PCI. Furthermore, such configuration instructions could comprise a software enabling enhanced handover triggers based on a position or speed acquired by a specific HW component.

In embodiments, in the updating 330 step, the obtained configuration instructions are used to update the software or configurations of the communication device. Through the update to software or configurations of the communication device the communication behaviour may be modified.

In an embodiment, the communication device provides 310 a PCI, indicating, to a network that the communication device supports a particular API to a Network e.g. Network API X, or a particular API to a Radio Access network, e.g. Radio API Y, (X and Y representing a generic versioning of the Network API). The communication device may obtain at 320, from the network node, configuration instruction, for example comprising a software component, which utilize an API feature only available in Network API X or Radio API Y, and optionally later versioning, (e.g. X+1, Y+1) as the API may be backwards compatible. The communication device's functionality is controlled by the communication device updating its API features to enable the utilizing of the API features available in Network API X or Radio API Y. As such, the communication behaviour of the communication device is modified to enable the communication device to perform function using the Network API X features.

In some embodiments, the communication device provides at least one PCI indicating that the communication device supports GNSS positioning. The communication device may obtain configuration instructions, for example comprising a software component that provides enhanced handover triggers based on a position or speed, of the communication device, provided by the GNSS HW. The communication device's functionality is thus controlled by updating the handover triggers, of the communication device, to utilize the position or speed provided by the GNSS, to perform handovers according to the updated handover triggers.

In further embodiments, the communication device provides at least one PCI indicating that the communication device supports HW acceleration for advanced encryption or integrity protection of user data. The communication device may obtain configuration instructions, for example comprising a software component utilizing the HW acceleration to support a secure crypto algorithm, using the capability of HW acceleration, for advanced encryption or integrity protection of user data. The communication device's functionality is controlled updating the secure crypto algorithm to utilize the HW acceleration for advanced encryption or integrity protection.

In an optional receiving 303 step the communication device receives a request from a sender to provide at least one PCI. In an embodiment, the sender is a network node. In another embodiment, the sender is for example another node of a network or an over-the-top sever. The request may comprise an indication for the communication device to provide at least one PCI of the communication device. Further, the communication device may provide the PCI, at 310, in response to the request for at least one PCI received from the network node. The request may further comprise an indication for all PCIs to be provided. The request may even further comprise an indication for only a subset of the communication device's PCIs to be provided. In an embodiment, the request comprises instructions to the communication device for providing the PCI's to the sender, e.g. if the PCIs are to be sent using specific means, uploaded on a specific channel, or if the PCIs are to be uploaded to a specific server.

The request may, be received in a dedicated RRC or NAS message. In another embodiment, the requested is received in a broadcasted message.

In an optional step, Occurrence 307 of an event, the communication device initiates the providing of a PCI when a predetermined event occurs. Such a predetermined event may for example be the initiation of a registration of the communication device to a network or an over-the-top server. A further predetermined event may be the completion of the registration of the communication device to a network or an over-the-top service. In some embodiments, a timer is utilized to indicate the predetermined event. As such, the communication device would have access to a timer. Upon lapse or time-out of the timer, the communication device is triggered to initiate the providing of a PCI. In another embodiment, the timer is initiated upon an initial providing of a PCI. As such, the timer may then initiate another provisioning of the PCI. In other words, after a first provision of the PCI, a timer may be initiated which, when lapsed, will initiate another provisioning of the PCIs available at the communication device, to the network node. In another embodiment, the timer is initiated upon any of the predetermined events as mentioned herein. Further predetermined events, which may initiate the providing of a PCI, may be the communication device entering (physically or virtually) a new area, cell, Public Land mobile Network (PLMN) or network slice.

A detection of the predetermined event may be programmed in software or hardware. The detection of the predetermined event may comprise noting a change from a deregistered state to a registered state. Further, such detection could be of the completion of an authentication procedure performed by the communication device and the network node. Further detection may be the identification of a change of, or a new, area, cell, PLMN or network slice.

As used herein, a timer may be a counter of measurements of time, frequency, vibrations, or other periodic measurements.

In another embodiment, the PCI is signed with a secure checksum. This enables the network to verify the capability information, thereby ensuring that the capability information has not been modified or tampered with. The secure checksum may be a SHA-256, a MD5 or any other secure checksum. In some embodiments, the checksum is calculated and verified using a public key. In further embodiments, the checksum is calculated and verified using a private key. In even further embodiments, the checksum is calculated and verified using a shared secret key. Further, the PCI may be encrypted using similar keys, e.g. the public key, the private key, and/or the shared secret key.

The information can be a numerical value, a string, a symbol, binary code, or other type of information display.

In an optional step, indicating an updated PCI the communication device may indicate 335 to the network node if the PCI has been updated since the previous provisioning of a PCI to a network node.

In an embodiment, the PCI is associated with an index, a transaction ID, or version identifier. More specifically, the communication device may indicate to a network when an update of the PCI has occurred, using the index, or transaction ID or version identifier. An advantage of this is that the network is enabled to re-request an updated PCI. This enables the network node to, in a timely manner, incorporate the newest PCI in the configuration instructions sent to the communication device to modify the communication behaviour of the communication device.

FIG. 4 illustrates a method 400 performed by a network node for enabling the modification of at least one communication device's communication behaviour with regard to how the communication device communicates in a network.

The method 400 comprises obtaining 410 at least one PCI from the at least one communication device, providing 420 the communication device with configuration instructions which utilize one or more of the at least one PCI obtained from the communication device.

The obtaining of the PCI may comprise receiving the PCI as at least one information element in RRC or NAS signalling. Further, the obtaining of the PCI may comprise retrieving or receiving the PCI using FTP, STFP or HTTP. For example, a HTTP message may be a HTTP GET or HTTP POST message. Furthermore, examples of (S)FTP messages include (S)FTP GET and MGET messages, and (S)FTP PUT and MPUT messages. In an embodiment, the network retrieves the PCI from a server pointed to by a URL provided by the communication device.

The PCI may be obtained from an uploaded PCI, or a PCI received from a communication device. For example, retrieving an uploaded PCI may be performed using FTP, SFTP or HTTP, such as an (S)FTP GET, or MGET messages, or a HTTP GET message. Another embodiment includes obtaining the PCI as an Information Element in an RRC message, for example in an RRC measurement report, or configuration of user plane radio bearers, or an NAS message, for example, in a authentication procedure message, or connection procedure message. In some embodiments, the network node obtains the PCI by obtaining a pointer or an index to a predefined set of PCIs. In other embodiments, such a pointer is a URL to a server from which the network node can retrieve the PCI.

In the second step providing 420 of configuration instructions the configuration instructions may comprise a software configuration, software code, and/or configuration instructions. In other words, the configuration instructions may comprise instructions for the communication device to utilize specified capabilities, the capabilities indicated to be programmable using PCIs.

In an optional step, initiating 405 a request for at least one PCI, the network node may initiate a request for at least one PCI from the communication device. In other words, the network node may initiate sending a request to the communication device, requesting at least one PCI from the communication device. In a further embodiment, the request comprises an indication whereby all PCIs are requested. Even further, the request may comprise an indication indicating that a subset of the communication device's PCIs is requested.

In a further embodiment, the request comprises instructions to the communication device to enable the network node to obtain the PCI. In other words, the request may comprise instructions, instructing the communication device how to provide the PCI to the network node. For example, such instructions may comprise indications to utilize FTP, SFTP, HTTP, RRC and/or NAS messages or signalling.

The request may be sent as a dedicated RRC or NAS message. In an embodiment, the request is sent as a broadcast message by the network node.

In an optional step, obtain 425 indication of updated PCI, the network node obtains indications from the communication device which indicate that the communication device's PCIs have been updated. The indication can be obtained using an index or using a transaction ID.

In another optional step, initiating 435 a re-request for at least one PCI, the network node initiates a re-request for at least one PCI. In some embodiments, a re-request for a PCI is initiated by the network node if no PCIs where provided upon an initial request. In another embodiment, the network node initiates a request upon being provided with an indication of an updated PCI. In other words, if the network node has received an indication that a PCI is updated, the network node may initiate a request to obtain the updated PCI.

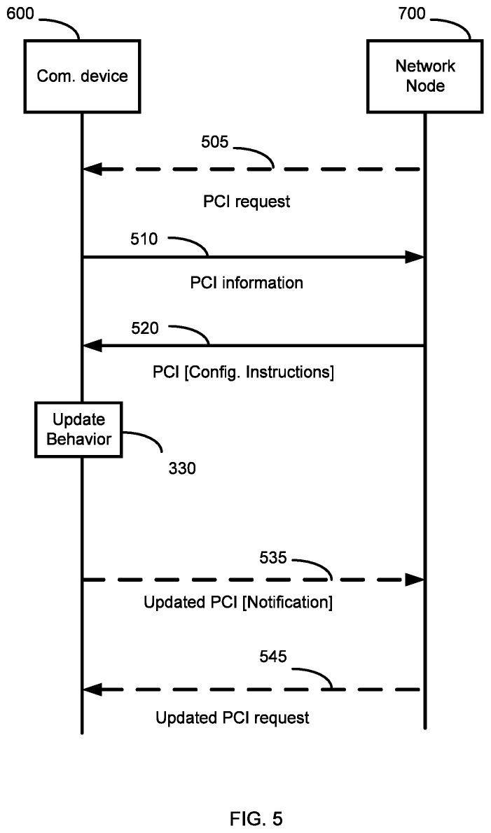

FIG. 5 illustrates a signalling diagram between two entities according to embodiments. For illustrative purposes, the signalling diagram shows, more specifically, signalling between a communication device and a network node. In a first message 510, the communication device provides, to the network node a PCI. For example, the message could be RRC or NAS messages. The network node, in response to obtaining the PCI, replies with a PCI configuration instruction message 520. The PCI configuration instruction message 520 comprises configuration instructions. The communication device, having obtained the configuration instructions from the network node, updates at 330 a behaviour of the communication device.

In the optional step 405, the network node according to some embodiments sends a message comprising a PCI request 505 to a communication device, the PCI request requesting a PCI of a communication device. In some embodiments, the PCI request 505 comprises further instructions on how to provide a PCI to the network node. In another optional signalling message, the communication device informs the network node that at least one PCI has been updated. In other words, after an update of a communication device's PCI, the communication device may provide an indication of said updated PCI to a network node in an update message 535.

In an even further optional signalling message, the network node provides, to the communication device, another request for PCIs (the requested PCIs may be the same PCIs as requested in PCI request 505, the requested PCIs may be PCIs indicated to be updated in a signalling message 535). In an embodiment illustrated in FIG. 5, the another request for PCIs is an Updated PCI request message 545 for PCIs in response to an updated PCI message 535.

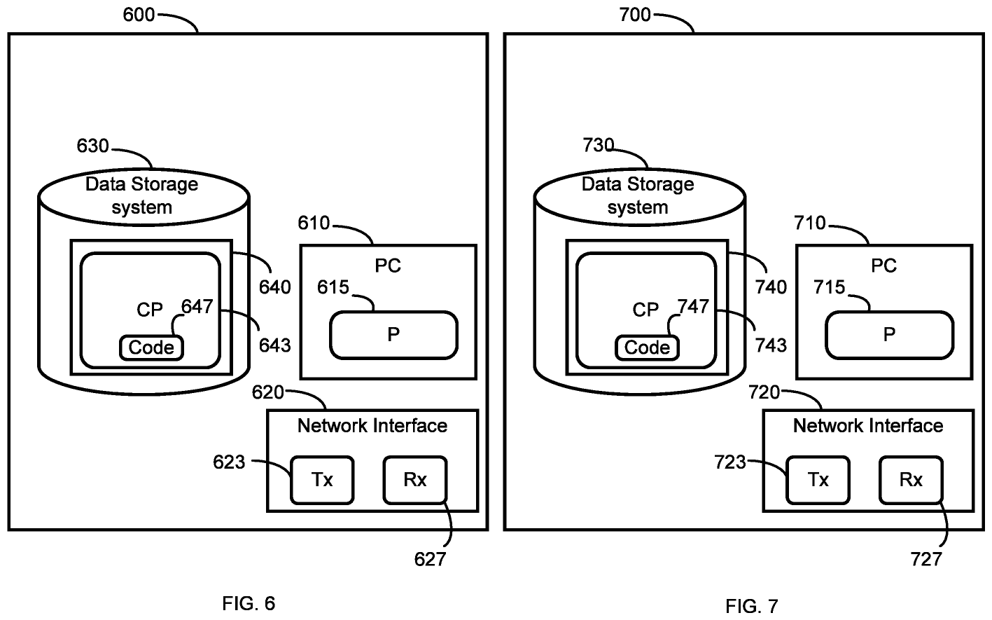

FIG. 6 illustrates a block diagram of an embodiment of a communication device 600. As shown in FIG. 6, communication device 600 comprises processing circuitry (PC) 610 which includes one or more processors 615, e.g. any one of a general purpose microprocessor, one or more data processing circuits, such as an application specific integrated circuits and/or field-programmable gate arrays. The processing circuitry may be located in a single housing or data centre or may be geographically distributed. The communication device 600 in some embodiments further includes a network interface 620, comprising a transmitter 623 and/or a receiver 627 for enabling the communication device 600 to transmit data to, and receive data from, nodes connected to a network with which the communication device is in communication. Moreover, the transmitter 623 and receiver 627 may be coupled to one or more antennas (not shown) and may share circuit components, software or firmware, (for example in a joint transceiver implementation) or alternatively be implemented separately. The communication device 600 further comprises a data storage system 630 which may include one or more non-volatile storage devices and/or one or more volatile storage devices. The data storage system 630 of FIG. 6 comprise a computer program product 640 in the form of a data storage for storing information, which may include one or more computer readable storage medium in the form of non-volatile memories, and/or one or more volatile memories such as random-access memory. The computer program product comprises a computer program 643, which comprises computer instructions or code 647. The computer readable storage medium can be a non-transitory computer readable medium such as, a magnetic media where a hard disk is an example thereof, optical media, such as a DVD, and a flash memory. The computer instructions of the computer program are configured such that when executed by computer the computer instructions cause the computer to perform some or all of the functions and operations described herein.

FIG. 7 illustrates a block diagram of an embodiment of a network node 700. As shown in FIG. 7 network node 700 may comprises processing circuitry 710 which includes one or more processors 715, e.g. any one of, a general purpose microprocessor, and/or one or more data processing circuits, such as an application specific integrated circuits, and field-programmable gate arrays, which processors may be located in a single housing or data centre or which may be geographically distributed. The network node in some embodiments further includes a network interface 720, comprising a transmitter 723 and a receiver 727 or a transceiver for enabling the network node to transmit data to and receive data from other nodes connect to a network. Moreover, the transmitter 723 and receiver 727 may be coupled to one or more antennas and may share circuit components, software or firmware, (for example in a joint transceiver implementation) or alternatively be implemented separately. The network node further comprises a data storage system 730 which may include one or more non-volatile storage devices and/or one or more volatile storage devices. The data storage system 730 of FIG. 6 comprises a computer program product 740 in the form of a data storage for storing information, which may include one or more computer readable storage medium in the form of non-volatile memories, and/or one or more volatile memories such as random access memory. The computer program product comprises a computer program 743, which comprises computer instructions or code 747. The computer readable storage medium can be a non-transitory computer readable medium such as, a magnetic media where a hard disk is an example thereof, optical media, such as a DVD, and a flash memory. The computer instructions of the computer program are configured such that when executed by computer the computer instructions cause the computer to perform some or all the functions and operations described herein.

The various embodiments described herein may be implemented in a recording medium readable by a computer or its similar device by employing for example, software, hardware or combinations thereof.

A software implementation of the embodiments described may be implemented as procedures and functions that may be implemented in separate modules and/or computer program parts, each of which is written to cause a computer system to perform one or more of the functions and operations described herein. Software codes may be implemented using a software application written in any suitable programming language.

As used herein a network node may be a physical network device, such as in a radio access network device, a radio core network device, a distributed networks system node and, in some embodiments, a distributed network node such, as a computing platform (e.g a cloud computing platform) node, e.g. a server, an over-the-top server, or a virtual network node which can be implemented in a cloud.

Further, the network node as a radio network node may be a radio base station in the form of a standardized base station, such as nodeB or evolved NodeB (eNB) for Long Term Evolution (LTE), or gNodeB for New Radio (NR).

It will be appreciated that the radio network node may further refer to a base transceiver station, an access point, a network control node such as a network controller, a radio network controller, a base station controller, and the like or some combination thereof. The network node may be a modem, hub, bridge, switch or other data communication equipment, or a data terminal equipment such as a host computer.

As used herein the term communication device, which may be known as a “wireless terminal” or a “User Equipment” (UE), may refer to a mobile phone, a cellular phone, a Personal Digital Assistant (PDA) equipped with radio communications capabilities, a smart phone, an iPAD, a USB dongle e.g. with a radio modem, a laptop or personal computer (PC) equipped with an internal or external mobile broadband modem, a tablet PC with radio communication capabilities, laptop embedded equipment, laptop mounted equipment, a device-to-device UE, a machine type UE, a UE capable of machine to machine communications, customer premises equipment, a portable electronic radio communication device, a sensor device equipped with radio communication capabilities, a telematics unit within a vehicle, a vehicle-mounted or vehicle embedded wireless device, a VR headset, a display, a loudspeaker or other media delivery device, etc. In particular, the term “communication device” should be interpreted in non-limiting terms to include any type of wireless device communicating with a radio network node in a cellular or a mobile communication system. As such, a communication device may be any of a wide variety of communication devices.

One way to utilize capabilities of communication devices which are not directly programmable would be to define one or more API to provide a function call, which the programmable part of the communication device can utilize when the device needs access to HW related capabilities, such as movement speed measurements. APIs may be specified by a standardization organization, or they may be published by a device vendor. The functions to be covered by an implemented API can be specified by the device vendor. Information that may be comprised within the API could include information relating to performance of the HW, e.g. a duration before the API call is completed, or how many cells a communication device can measure simultaneously, or the bandwidth scannable by the communication device.

In the present context, the term virtualizing means creating virtual versions of apparatuses or devices, which may include virtualized hardware platforms, storage devices and networking resources. As used herein, virtualization can be applied to any device described herein, or components thereof, and relates to an implementation in which at least a portion of the functionality is implemented as one or more virtual components.

While various embodiments of the present disclosure are described herein, it should be understood that they have been presented by way of example only, and not limitation. Thus, the breadth and scope of the present disclosure should not be limited by any of the above-described exemplary embodiments. Moreover, any combination of the above-described elements in all possible variations thereof is comprised by the disclosure unless otherwise indicated herein or otherwise clearly contradicted by context. Additionally, while the processes described above and illustrated in the drawings are shown as a sequence of steps, this was done for the sake of illustration only, unless otherwise stated. It is contemplated that some steps may be added, some steps omitted, the order of the steps may be re-arranged, and some steps may be performed in parallel.

1.-50. (canceled)

51. A method performed by a communication device for modifying a communication behavior of the communication device with regard to communication in a network, wherein the communication behavior is modified by controlling the functionality of the communication device, the method comprising:
providing at least one programmability capability indicator, PCI, to a network node, wherein the at least one PCI comprises an indication of one or more supported application programming interfaces, APIs;
obtaining, from the network node, configuration instructions provided in response to the providing of the at least one PCI; and
updating the communication behavior utilizing the obtained configuration instructions.

52. The method of claim 51, wherein said configuration instructions are related to at least one of radio processing, packet processing, a network selection, and a service layer functionality of the communication device.

53. The method of claim 51, further comprising:
indicating, to the network node, an update of the at least one PCI utilizing an index, a transaction ID or a version identifier, associated with the PCI.

54. The method of claim 51, wherein the at least one PCI comprises an indication of one or more of:
A) processing hardware, HW capabilities;
B) memory capabilities;
C) supported bit-rates or packet processing capabilities;
D) supported HW components.

55. The method of claim 51, wherein the one or more APIs comprise an API to at least one of a service layer, an Operating System layer, and an application layer function.

56. The method of claim 51, wherein the one or more APIs further comprise an API which is managed by an entity which is not a cellular network, for example a wi-fi module or an external data storage.

57. The method of claim 51, wherein the modified communication behavior comprises a protocol behavior of the communication device.

58. The method of claim 51, wherein the providing at least one PCI comprises sending the PCI as at least one information element in RRC or NAS signaling.

59. The method of claim 51, wherein the providing of at least one PCI comprises sending the PCI using File Transfer Protocol, Secure shell File Transfer Protocol or Hypertext Transfer Protocol.

60. The method of claim 51, wherein the method further comprises receiving a PCI request, from the network node, to provide at least one PCI, and providing at least one PCI in response to the received request to provide at least one PCI.

61. The method of claim 51, wherein the obtaining of the configuration instructions comprises obtaining the configuration instructions using FTP, SFTP or HTTP.

62. The method of claim 51, comprises decrypting the PCI and/or the configuration instruction, signed with a secure checksum, such as Secure Hash Algorithm, or Message-digest algorithm or another secure checksum and the checksum is calculated and verified using either a public key, a private key or a shared secret key.

63. The method of claim 51, comprises encrypting the provided PCI using a public key, a private key or a shared secret key.

64. A communication device for communicating with a communications network, the communication device comprising:
a processor;
a transceiver; and
a memory storing instructions that, when executed by the processor, cause the communication device to:
modify the communication behavior of the communication device by controlling the functionality of the communication device, the communication device further adapted to:
provide at least one programmability capability indicator, PCI, to a network node;
obtain, from the network node, configuration instructions provided in response to the provided at least one PCI, wherein the at least one PCI comprises an indication of one or more supported application programming interfaces, APIs;
update the communication device's communication behavior utilizing the obtained configuration instructions.

15. A computer program product comprising a computer program comprising computer program code, to be executed by the at least one processor of a communication device whereby the execution of the program code causes the communication device to perform operations according to claim 1, and a computer readable storage medium on which the computer program is stored.
